(19) United States
(12) Patent Application Publication
(10) Pub. No.: US 2024/0341364 A1
(43) Pub. Date: Oct. 17, 2024

(54) AEROSOL PROVISION ARRANGEMENT

(71) Applicant: NICOVENTURES TRADING LIMITED, London (GB)

(72) Inventors: David Rushforth, London (GB); Damyn Musgrave, London (GB)

(21) Appl. No.: 18/579,712

(22) PCT Filed: Aug. 2, 2022
(86) PCT No.: PCT/GB2022/052033

§ 371 Date: Jan. 16, 2024

(30) Foreign Application Priority Data
Aug. 2, 2021 (GB) 2111129.9

(51) Int. Cl. A24F 40/49; A24F 40/53; A24F 40/65

(52) U.S. Cl. CPC A24F 40/49; A24F 40/53; A24F 40/65

(57) ABSTRACT

There is provided an aerosol provision arrangement for providing an aerosol to an authorised user, the aerosol provision arrangement comprising: an aerosol provision device comprising control circuitry for receiving signals and controlling an activation state of the aerosol provision device; an emitter associated with an authorised user, arranged to send a signal to the control circuitry of the aerosol provision device; and a power source, wherein the emitter comprises energy reception circuitry arranged to receive, indirectly, energy from the power source, and wherein the control circuitry is arranged to change an activation state of the aerosol provision device upon receiving a signal from the emitter associated with an authorised user.

### TECHNICAL FIELD

The present invention relates to an aerosol provision arrangement, a method of providing an aerosol in an aerosol provision arrangement, and an aerosol provision means.

### BACKGROUND

Aerosol provision systems are known. Common systems use heaters which are activated by a user to create an aerosol by an aerosol provision device from an aerosol generating material which is then inhaled by the user. The device may be activated by a user at the push of a button or merely by the act of inhalation. Modern systems can use consumable elements containing the aerosol generating material. It can be desirable for the manufacturer to enable control over the activation of the systems, whether in light of the particular consumable element in the aerosol provision device or otherwise. This may avoid activation of the system in undesirable circumstances.

The present invention is directed toward solving some of the above problems.

### SUMMARY

Aspects of the invention are defined in the accompanying claims.

In accordance with some embodiments described herein, there is provided an aerosol provision arrangement for providing an aerosol to an authorised user, the aerosol provision arrangement comprising: an aerosol provision device comprising control circuitry for receiving signals and controlling an activation state of the aerosol provision device; an emitter associated with an authorised user, arranged to send a signal to the control circuitry of the aerosol provision device; and a power source, wherein the emitter comprises energy reception circuitry arranged to receive, indirectly, energy from the power source, and wherein the control circuitry is arranged to change an activation state of the aerosol provision device upon receiving a signal from the emitter associated with an authorised user.

Such an arrangement is able to ensure that unauthorised users are prevented from using the arrangement while authorised users are enabled to use the arrangement. The security and control over the usage of the device is therefore improved. In particular, the aerosol provision device may be activated once the message is received from the emitter. As the emitter is associated with, such as being in the possession of, an authorised user, only authorised use can occur. This can assist in preventing unauthorised use of the device.

In accordance with some embodiments described herein, there is provided a method of providing an aerosol from an aerosol provision arrangement, the method comprising operating a power source to emit energy; using, by an emitter, at least a portion of the emitted energy from the power source to send a signal; receiving, by control circuitry, the signal from the emitter; reviewing, by the control circuitry, the signal against a signal repository; changing, by the control circuitry, an activation state of an aerosol provision device according to the signal.

In accordance with some embodiments described herein, there is provided aerosol provision means comprising: an aerosol provision device comprising control means for receiving signals and controlling an activation state of the aerosol provision device; and, emitting means associated with an authorised user, arranged to send a signal to the control means of the aerosol provision device, power means, wherein the emitting means comprises energy reception circuitry arranged receive, indirectly, energy from the power means, and wherein the control means is arranged to change an activation state of the aerosol provision device upon receiving a signal from the emitting means associated with an authorised user.

### DESCRIPTION OF DRAWINGS

The present teachings will now be described by way of example only with reference to the following figures:

FIG. 1 is a schematic view of an aerosol provision arrangement according to an example;

FIG. 2 is a schematic view of an aerosol provision arrangement according to an example;

FIG. 3 is a flow diagram according to an example; and,

FIG. 4 is a schematic view of an aerosol provision arrangement according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporize”, “volatilised” and “aerosolize”, may generally be used interchangeably.

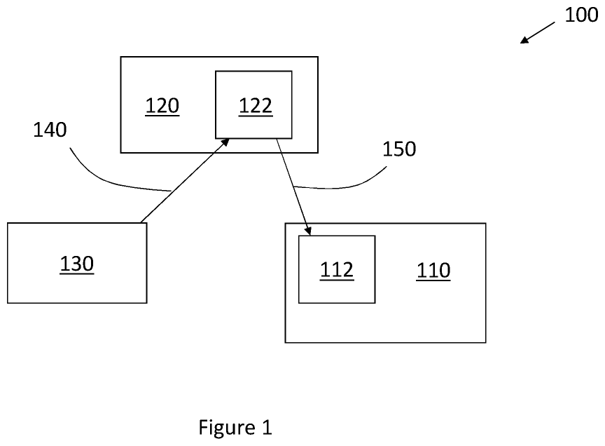

FIG. 1 illustrates a schematic view of an example of an aerosol provision arrangement 100 according to the present invention. The aerosol provision arrangement 100 has an aerosol provision device 110. The aerosol provision device 110 has control circuitry 112. The control circuitry 112 is arranged to receive signals and control an activation state of the aerosol provision device 110. The aerosol provision arrangement 100 has an emitter 120 associated with an authorised user. The emitter 120 is arranged to send a signal to the control circuitry 112 of the aerosol provision device 110. The aerosol provision arrangement 100 has a power source 130. The emitter 120 has energy reception circuitry arranged to receive, indirectly, energy from the power source 130. The control circuitry 112 of the aerosol provision device 110 is arranged to change an activation state of the aerosol provision device 110 upon receiving a signal from the emitter 120 associated with an authorised user.

The emitter 120 has energy reception circuitry arranged to receive, indirectly, energy from the power source 130. “Indirectly” here is related to the intended recipient of the energy from the power source 130. In use, the power source 130 may be sending messages or delivering power not intended for the emitter 120. The emitter 120 is therefore receiving energy indirectly from the power source 130. The emitter 120 is able to scavenge for energy from signals or power usage in a nearby vicinity. The emitter 120 may otherwise be described as being capable of leaching energy from nearby power sources, power transfers or energy uses without having a material impact on the intended use of sending messages or delivering power. The emitter 120 may be described as parasitic in terms of obtaining energy from a power source.

The emitter 120 may be arranged to receive, wirelessly, energy from a power source 130. As the emitter 120 is scavenging energy from the normal usage of the power source 130, there is no requirement for the power source 130 to be connected, physically or electrically, to the emitter 120. A coupling may be achieved via electromagnetic fields to assist indirect obtaining of energy. Indeed, an advantage of the emitter 120 receiving, indirectly, energy from the power source 130 is the particularly energy efficient method of use. Further, the design of the emitter 120 is much simpler as the emitter 120 has a small on-board power source (such as a capacitor such as an electric double layer capacitor) and energy reception circuitry 122 for receiving and utilising the indirectly obtained energy from the power source 130. A further advantage is that there is no requirement in this arrangement 100 for a reader in the aerosol provision device 110 (or the like) which excites the emitter 120 prior to emitting the signal to the aerosol provision device 110.

The emitter 120 may be arranged to scavenge energy from the surrounding area. The indirectly received energy may be in the form of electrical energy, from electrical or electromagnetic signals from the power source 130. In an example, the power source 130 may be an electrical power source 130.

In another example, the indirectly received energy may be in the form of kinetic or heat energy from a power source 130. In an example, therefore, the power source 130 may be an electrical power source 130 that provides thermal energy as a by-product of use. The power source 130 may be a battery or capacitor or the like, an electrical charge storage with controllable release. The power source 130 may be a motive or thermal power source 130. An example of a thermal power source 130 may be a heater, while a motive power source may be the movement of an authorised user associated with the emitter 120.

In the example of FIG. 1, the emitter 120 has energy reception circuitry 122 for receiving energy from a power source, in the form of indirect or scavenging processes.

The aerosol provision device 110 in the example shown in FIG. 1 has control circuitry 112 which can control operational aspects of the aerosol provision device 110. In particular, the control circuitry 112 may send a signal to a heater, heating element, atomiser, vibrating plate, other aerosol generating element or the like in the aerosol provision device 110 to allow activation or to cause activation of the aerosol provision device 110. The signal from the control circuitry 112 is triggered by the signal 150 sent from the emitter 120 associated with the authorised user. The emitter 120 sends signal 150 to the aerosol provision device 110 upon indirectly receiving energy 140 from power source 130.

As such, in one use scenario, a user uses their emitter 120 to send an authentication signal 150 to the aerosol provision device 110 to enable activation of the aerosol provision device 110. The power source 130 is used prior to this and energy 140 is scavenged from the power source 130 usage. This enables a signal 150 to be sent from the emitter 120. In the example shown in FIG. 1, the emitter 120 has no power source of its own. In the example of FIG. 1, the power source 130 is separate to the emitter 120 and the aerosol provision device 110. The separate provision of items can provide problems to overcome in the form of transferring of energy and information. The proposed solution is both energy efficient and cheap as the components of aerosol provision arrangement 100 can remain separate but also operate on very low power levels, prior to authorised activation of the aerosol provision device 110.

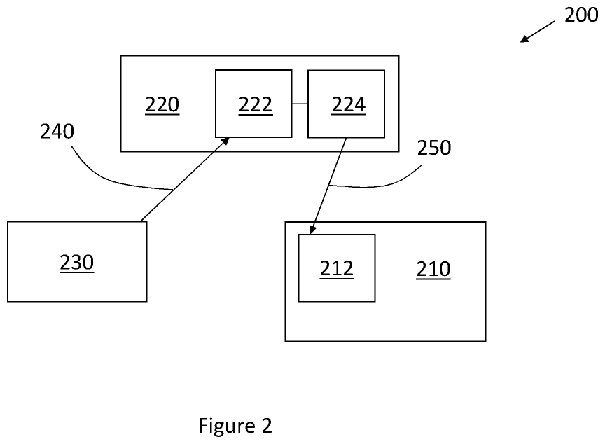

Referring now to FIG. 2, there is a shown a similar arrangement 200 to the arrangement 100 of FIG. 1. Similar features, to those features used in FIG. 1, are shown with the reference numerals increased by 100. For example, the arrangement 100 of FIG. 1 is similar to the arrangement 200 of FIG. 2. Similar or identical features may not be discussed for conciseness.

The emitter 220 of the arrangement 200 shown in FIG. 2 has a main body, the main body housing the energy reception circuitry 222 and emitter circuitry 224. The energy reception circuitry 222 scavenges energy 240 from nearby power sources 230 or uses of power. The energy reception circuitry 222 provides this energy to the emitter circuitry 224. The emitter circuitry 224, powered by the energy reception circuitry 222, sends a signal 250 to the control circuitry 212 of the aerosol provision device 210. These two elements 222, 224 may be in the same circuitry or may be separate and electrically connected via a wire, or wirelessly. The two elements 222, 224 may have at least one component in common and/or at least one component not in common. The two elements 222, 224 may be part of the same integrated circuit using different antenna. In such an arrangement, the antenna 222 for energy harvesting may be different to the antenna 224 for emitting the signal.

The emitter 220 has a small integral power source, which scavenges and stores energy from nearby power transmissions or signals. The arrangement 200 utilises energy scavenging from uses of, or transmissions from, the power source 230. The integral power source of the emitter 220 allows for burst-like power use during transmission of the authentication signal. The power source in the emitter 220 allows energy to be captured and built up between transmissions of the signal (that may be burst-like in performance). Therefore, the power source may be a capacitor or the like for storing power. The power source sends power to the integrated circuitry of the emitter for the transmission of the signal. After the power is received, stored and built up, a “burst” relates to a sending of a signal from the emitter.

The power source 230 may be messaging another item or component, not in the arrangement 200, and the energy reception circuitry 222 receives this energy (from the messaging) indirectly. The energy reception circuitry 222 may require very low energy levels to provide energy to the emitter circuitry 224 for a message 250 to be sent to the aerosol provision device 210. Hence this arrangement 200 is highly electrically efficient.

The energy reception circuitry 222 may comprise an antenna. In a specific example, the energy reception circuitry 222 comprises a patch antenna. In other examples, the energy reception circuitry 222 may comprise any of a patch antenna, a slot antenna, a wire dipole antenna, planar inverted-F antenna, spiral antenna, fractal antenna, fractal polygon antenna, meandering path antenna, or the like. The antenna may be any that can convert electromagnetic power to electrical power (or vice versa). The control circuitry 212 of the aerosol provision device 210 may also comprise an antenna arranged to receive the signal 250 from the emitter circuitry 224.

The signals from the emitters enable the aerosol provision device 210 to be in or change to a specific activation state. An activation state may be an operating state, i.e. the aerosol provision device 210 can be operated to generate an aerosol, a different activation state may be a non-operating state, where the aerosol provision device 210 cannot be operated to generate an aerosol. The aerosol provision device 210 may have a number of activation states associated with different emitters (and their different signals 250). In this way, the aerosol provision device 210 can provide a personalised activation state (which may include heating profiles or the like) for each user's emitter.

In an operating state, elements of the aerosol provision device 210 used to generate an aerosol (such as an atomiser, heater or the like) may be activated. The specific activation of the device 210 may require an additional input which may be inhalation on the device 210, pressing a button on the device 210 or the like, alternatively the device 210 may automatically generate aerosol by a heater upon receiving an authorised signal by the control circuitry 212.

In a non-operating state, elements of the aerosol provision device 210 used to generate an aerosol (such as an atomiser, heater or the like) may not be activated. In this example, inhaling on the device or pressing a button makes no impact on the heater or atomiser etc.

The term “operating state” may refer to a number of states in which the device 210 can be operated. Similarly the term “non-operating state” may refer to a number of states in which the device 210 cannot be operated.

In a specific use example, the aerosol provision device 210 may be in a default activation state prior to any attempted use by a user. This default activation state may be a non-operating state. In this example, a user may not operate the aerosol provision device 210 until authentication has occurred via the signal 250 associated with the emitter 220 associated with the authorised user. By requiring the aerosol provision device 210 to unlock prior to use, there is an added safety aspect over allowing the default activation state to be an operating state. Further, in this example, if the user is not an authorised user and does not have an authorised emitter, upon receipt of a signal from the unauthorised emitter, the control circuitry 212 may not send a signal to the heater of the aerosol provision device 210 and there is no change in activation state of the aerosol provision device.

The aerosol provision device 210 is able to recognise signals from emitters. The aerosol provision device 210 is arranged to enable activation only for emitters that are associated with, such as belong to or are in the possession of, authorised users. The aerosol provision device 210 may be “taught”, or may “know”, which emitters are to be seen as authorised and which are not.

The aerosol provision device 210 may have circuitry that can contact an updateable database to check the emitter identity against a list of known authentic emitter identities. If the emitter is authentic, the aerosol provision device 210 is able to be activated after receiving a signal 250 from the emitter 220.

The aerosol provision device 210 may carry the database on-board, and process the signal 250 on-board. Alternatively, the database may be external to the aerosol provision device 210 and the aerosol provision device 210 sends the identity to a remote database and is provided with a response as to whether to enable or disable use of the aerosol provision device 210. On-board processing may be faster however the database may need to be updated when the aerosol provision device 210 is connected to WiFi or the like. On-board processing has the advantage of being able to function in areas of very poor connectivity. Remote processing does not rely on the aerosol provision device 210 carrying a database and ensuring it is up to date. However, this processing may be slower and require connectivity to e.g. WiFi prior to use.

In the example where the processing of the signal is performed on the aerosol provision device 210, the processing may take the form of comparing the data from the emitter 220 (the signal 250 from the emitter 220) against an on-board database of registered and/or authenticated emitters 220 and users and the signals 250 from said emitters 220. If there is a match, the signal 250 indicates the emitter 220 is authorised, and therefore the user is authorised, and the device 210 is able to function. If there is not a match, the aerosol provision device 210 may request the user to try again and send a further signal to the aerosol provision device 210. If there is not a match, the aerosol provision device 210 may prevent activation of the aerosol provision device 210.

In a specific use example, a first user attempts to access the aerosol provision device 210 and, separately, a second user attempts to access the aerosol provision device 210. The emitter 220 of the first user provides a signal 250 to the control circuitry 212 of the aerosol provision device 210. If the first user is authorised, the control circuitry 212 allows the aerosol provision device 210 to function and can activate a heater for use by the user to provide an aerosol. The operating state of the aerosol provision device 210 is therefore in an active, operating state for the first user.

The second user may attempt to use the aerosol provision device 210. The emitter 220 of the second user provides a signal 250 to the control circuitry 212 of the aerosol provision device 210. If the user 250 is not authorised, the control circuitry 212 may prevent the aerosol provision device 210 from being activated. This may involve leaving the aerosol provision device 210 in a non-operating state (if the device 210 was already in a non-operating state) or changing the state of the aerosol provision device 210 from operating to non-operating.

In the event that the first user is an authorised user and the second user is unauthorised, the operating state changes of the aerosol provision device 210 may be as described below.

Initially the device 210 is in a default activation state, which is a non-operating state. The emitter 220, using indirectly received energy from power source 230, of the first user sends a signal 250 to change the state of the device 210 to an operating state. The first user may subsequently use the device 210. After the first user has finished using, or deemed to have finished using, the device 210, such as after a smoking session, number of puffs, or after a predetermined period of time or the like, the device 210 may reset to a non-operating state. In this way, the user may need to change the state of the device 210 to an operating state before a further use session. Such an arrangement increases the safety of the device 210 by preventing an unauthorised user using the device 210 after an authorised user has changed the state of the device 210 to an operating state and finished their smoking session.

When the unauthorised second user attempts to access the device 210, the emitter 220 of the unauthorised user provides a signal 250 to the control circuitry 212. The control circuitry 212 may maintain the device 210 in a non-operating state, such that the second user is prevented from operating the device 210. Alternatively, the control circuitry 212 may, upon identifying the user as an unauthorised user attempting to use the device 210, change the state of the device 210 to a locked state.

A locked state may be a form of non-operating state wherein, before the device 210 can be used to provide an aerosol, an authorised user must be detected by the control circuitry 212 of the aerosol provision device 210. A locked state may require a further level of identification of an authorised user to enable the locked state to be changed to an unlocked operating state. This may be in the form of a password, passkey, alphanumerical sequence or the like. The use of such a locked state provides an indication to the authorised user than an attempt has been made to use the device 210 by an unauthorised user.

The term “activation state” as used herein includes operating and non-operating states. An operating state may be a state in which the device can be used. Other, more specific, operating states may dictate the performance of the device, such as selecting the heating mechanisms used, the heating profile used, the aerosol generating material used, etc. Such operating states may be associated with specific users. In this way, upon recognition of authorised user 1 (by signal 1 of emitter 1), corresponding heating mechanism 1 is used to provide heating profile 1 on aerosol generating medium 1. Upon recognition of authorised user 2 (by signal 2 of emitter 2), corresponding heating mechanism 2 is used to provide heating profile 2 on aerosol generating medium 2. In this way, different users can have their personalised aerosol provided upon recognition of that user.

Non-operating states may be a state in which the device cannot be used. Other, more specific, non-operating states include the default non-operating state, which can be changed by receiving a signal from an authorised emitter of an authorised user. Other non-operating states, such as a locked state, may require more than the satisfying of one criteria by a user (e.g. authorised emitter signal) to change the device to an operating state. This may assist in preventing the hacking of a device and can inform an authorised user of attempted accesses by unauthorised users. This arrangement therefore improves the overall protection provided by the arrangement.

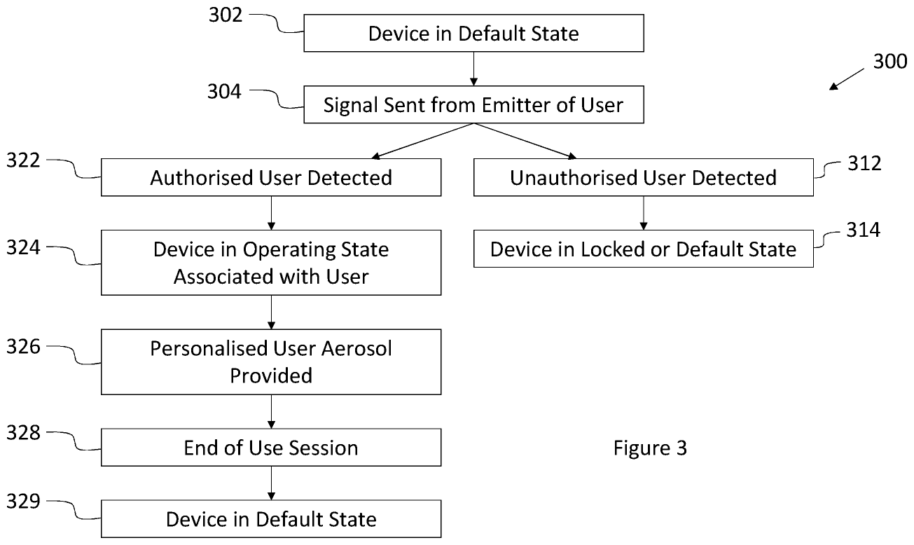

FIG. 3 shows a method 300 of use of an aerosol provision arrangement. In the method 300, the device starts in a default state 302. Before a user attempts to use the device, the user may be asked for identification via their emitter. The emitter of the user sends a signal 304 indicating a property of the user to the control circuitry of the aerosol provision device. As discussed above, the control circuitry of the aerosol provision device compares the signal against a memory, database (remote or on-board) or the like to confirm the authorisation level (authorised or unauthorised) of the user. If an unauthorised user is detected 312, the method goes on to step 314 wherein the device is put into a locked state or stays in the default state.

If an authorised user is detected 322 (i.e. an authorised emitter signal is detected), the device is changed to being in an operating state 324. As described above, this operating state may be associated with the user to provide a personalised aerosol. As such, a heater or atomiser in the aerosol provision device may be operated for a predetermined heating profile on predetermined aerosol generating medium to provide a personalised user aerosol to a user 326. After the user has ended their session, which may be indicated to the device by the user by pressing a button or after a given period of time or after a predetermined number of puffs, the use session is ended or deemed to have ended 328. After this, the device is returned to the default state 329 as in step 302. As such, use of the device disclosed herein can be protected against unauthorised use and unauthorised users.

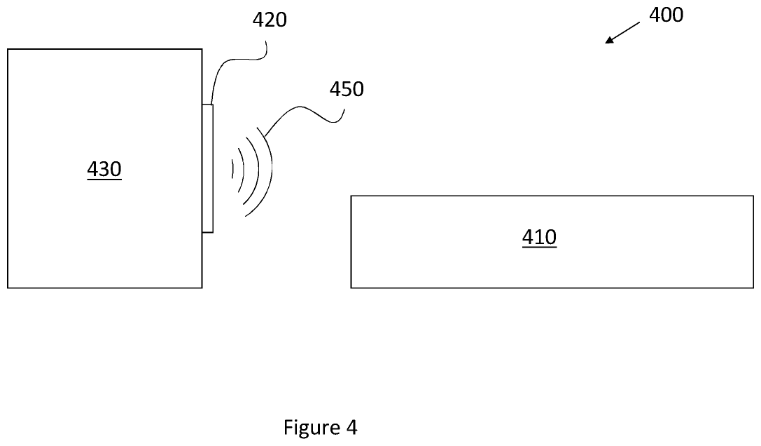

Referring now to FIG. 4, there is a shown a similar arrangement 400 to the arrangement 200 of FIG. 2. Similar features, to those features used in FIG. 2, are shown with the reference numerals increased by 200. For example, the arrangement 200 of FIG. 2 is similar to the arrangement 400 of FIG. 4. Similar or identical features may not be discussed for conciseness.

FIG. 4 shows a power source 430, with an emitter 420 adjacent the power source 430. The power source 430 is separate to the emitter 420 and the power source 430 is not integral with the emitter 420. The emitter 420 emits a signal 450. This signal 450 is received by the aerosol provision device 410 and, if the emitter 420 is authorised, the aerosol provision device 410 can use activated to provide an aerosol.

The emitter 420 may be able to transmit signals up to a range of 15 meters. The control circuitry of the aerosol provision device 410 may be arranged to receive a signal from the emitter 420 up to a range of 15 meters. Such emitters 420 utilise high power levels scavenged from the power source 430. As such, if the power source 430 is a high-power power source 430, long ranger emitters 420 may be advantageous to take advantage of such power sources 430. Such emitters 420 enable longer range use of the aerosol provision device 410 and may be preferable in instances wherein the emitter 420 is not commonly close to the user of the aerosol provision device 410. Such emitters 420 may operate using Bluetooth, Bluetooth LE, SigFox, NB-IoT, LoRaWAN and LTE-M or the like.

The emitter 420 may be able to transmit signals up to a range of 2 meters. The control circuitry of the aerosol provision device 410 may be arranged to receive a signal from the emitter 420 up to a range of 2 meters. Such an emitter 420 does not need a high-power power source 430 to operate. The emitter 420 can scavenge relatively low power signals and provide the low-power signal 450 over a relatively short range. A low-range emitter 420 is therefore compatible with a greater number of power sources 430 than the high-range emitter discussed above. Furthermore, the low-range emitter 420 increases the likelihood that the owner of the authorised emitter is in the vicinity of the aerosol provision device prior to use. In such a way, while it is more incumbent on the authorised user to carry the emitter 420 on their person, the aerosol provision device 410 is less likely to be used without the authorised user nearby, which increases the overall safety of the arrangement 400. It is less likely that an unintended signal 450 is provided to the aerosol provision device 410 in the example that the signal 450 can only be transmitted up a range of 2 meters or so. Such emitters 420 may operate using Bluetooth, Bluetooth LE or the like.

In a specific example, the power source 430 may be the battery of a mobile telecommunications device belonging to the authorised user. The emitter 420 may be a Bluetooth token which is stuck to the mobile device. The emitter 420 may be built into an external case for use with the mobile device. The emitter 420 abuts the mobile telecommunications device and uses energy in transmissions from the mobile telecommunications device to emit Bluetooth signals. As mentioned above, this scavenging of energy allows the arrangement 400 to operate in a particularly energy efficient manner.

In the example of FIG. 4, the power source 430 is part of a mobile telecommunications device, for example the battery. The aerosol provision device 410 is arranged to receive Bluetooth communications, so as to receive the signal 450 from the emitter 420. The aerosol provision device 410 therefore has some form of Bluetooth receiver. The mobile device 430 may be able to provide an override signal to the aerosol provision device 410, for example if the user has no access to the emitter 420 (or has lost the emitter 420). The mobile device 430 which is known by the aerosol provision device 410 as belonging to an authorised user, is able to control some functionality of the device 410 via an application on the mobile device 410.

The mobile device 430 and the aerosol provision device 410 may interact via an application on the smartphone or tablet or the like. The aerosol provision device 410 may be accessed by the smartphone or tablet to control some aspect of functionality of the aerosol provision device 410. The use of only authorised smartphones increases the prevention of unauthorised users accessing the aerosol provision device. Communication may occur via wireless protocols such as Bluetooth.

Bluetooth is one of a number of example technologies for use in this arrangement. Bluetooth is particularly useful due to the range and the power levels involved in Bluetooth. Alternatives include other connectivity technology such as personal area network protocols.

In an example of a method of use of the arrangement disclosed herein, the method steps may be: operating a power source to emit energy; using, by an emitter, at least a portion of the emitted energy from the power source to send a signal; receiving, by control circuitry, the signal from the emitter; reviewing, by the control circuitry, the signal against a signal repository; changing, by the control circuitry, an activation state of an aerosol provision device according to the signal.

The signal is received from the emitter that has scavenged energy from a use of the power source. The signal may be checked against a database or the like, as described above, and noted as being authorised or non-authorised. The activation state may be changed to an operating state if the signal is authorised or changed to a locked state is the signal is non-authorised. Alternatively, the activation state may remain in a default non-operating, but not locked, state if the signal is not authorised. The locked state may only occur after a predetermined number of non-authorised signals have been received by the aerosol provision device. As mentioned above, the checking against a database of authorised signals may occur on-board the aerosol provision device or remotely.

As described above, an authorised user is a user that is associated with an authorised emitter. In particular, an authorised user may have completed a verification check prior to obtaining the authorised emitter. Such a verification may be an age verification check. The check may occur at the point of sale of the emitter or the aerosol provision device. In this way, the user may be authenticated as being suitable to possess the authorised emitter. Therefore, an authorised user may have been through an authentication, or verification, step or the like.

As mentioned above, the energy reception circuitry may comprise an antenna. In a specific example, the energy reception circuitry comprises a patch antenna. In a further specific example, the energy reception circuitry may comprise two antennae. The first antenna may scavenge energy, as described above. The second antenna may be connected to the first via a diode. In an example, the diode may be a Shottky diode.

In use, the diode may remove half of the AC signal from the first antenna when it is sent to the second antenna. The second antenna may be tuned to a harmonic of the signal (in an example, the second harmonic). The harmonic signal may be emitted by the second antenna. The signal may be received by the aerosol provision device. The aerosol provision device may be programmed to recognise that if the second harmonic of the emitted original frequency is received, the signal being provided is one associated with an authorised user with an authorised emitter. The aerosol provision device may then receive the signal and change into an operating state.

Specifically, the aerosol provision device may be programmed that, if in response to emitting a frequency “f”, the aerosol provision device detects a signal at frequency “2f”, the aerosol provision device changes to an operating state.

Such an arrangement provides a very low cost solution to the problem of user recognition. In particular, the two antenna arrangement is a very low cost user authentication solution that operates on very low power requirements.

Example personal area network protocols include Bluetooth™, Bluetooth Low Energy™ (BLE), Zigbee™, Wireless USB, and Near-Field Communication (NFC). Example personal area network protocols also include protocols making use of optical communication such as Infrared Data association (IrDA), and data-over-sound. Other wireless technologies such as a Wi-Fi™ technology may be used if the aerosol provision device has suitable capability.

While the above discussion mostly focuses on Bluetooth, and implicitly, BLE technology, it will be appreciated that corresponding or equivalent functionalities of other personal area network technologies may be used. Thus, in above examples, the emitter and aerosol provision device operate using Bluetooth interfaces but may use a radio antenna for wireless communication. In other examples, the emitter and aerosol provision device may use an alternative wireless technology.

In another arrangement of the above disclosure, the aerosol provision device may act such that the emitter sends a signal. The emitter may send signals in one or more of the following circumstances:
1) Sufficient energy has been scavenged by the energy reception circuitry of the emitter (asynchronous signalling)
2) On a regular period, provided the energy captured by the energy reception circuitry of the emitter is sufficient (synchronous signalling)
3) When initiated by another message, such as one emitted by the vaping device (requested signalling)

In example (3) above, this enables the aerosol provision device to message the emitter and then listen for a response prior to activating the aerosol provision device for use. The integrated circuit of the emitter may have a wake-up feature that allows the emitter to use a very low standby power. The state of the emitter may then be changed once the message is received by the emitter from the aerosol provision device.

In a particular example, the arrangement disclosed herein may operate via wireless charging. Specifically, the emitter has energy reception circuitry arranged to receive, indirectly, energy from the power source. The power source may be the power source associated with a mobile device or the like. The power source may also or alternatively be a power source arranged to charge a mobile device or the like. Specifically, the power source may be a source of Qi charging from which the emitter can store energy prior to releasing a signal. The emitter may have a small rechargeable cell (or capacitor or the like) in which to store energy prior to releasing a signal. In such an example, the magnetic resonance charger charges the antenna of the emitter.

The emitter may have any number of antennae.

In a particular example, the device disclosed herein may operate with a flavour pod which is replaceable in the device. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating medium, the aerosol provision device as disclosed herein may be referred to as an aerosol provision system.

Thus there has been described an aerosol provision arrangement for providing an aerosol to an authorised user, the aerosol provision arrangement comprising: an aerosol provision device comprising control circuitry for receiving signals and controlling an activation state of the aerosol provision device; an emitter associated with an authorised user, arranged to send a signal to the control circuitry of the aerosol provision device; and a power source, wherein the emitter comprises energy reception circuitry arranged to receive, indirectly, energy from the power source, and wherein the control circuitry is arranged to change an activation state of the aerosol provision device upon receiving a signal from the emitter associated with an authorised user.

Thus there has also been described an aerosol provision arrangement for providing an aerosol to an authorised user, the aerosol provision arrangement comprising: an aerosol provision device comprising control circuitry for receiving signals and controlling an activation state of the aerosol provision device; an emitter associated with an authorised user, arranged to send a signal to the control circuitry of the aerosol provision device; and a power source, wherein the emitter comprises energy reception circuitry arranged to scavenge energy from the power source, and wherein the control circuitry is arranged to change an activation state of the aerosol provision device upon receiving a signal from the emitter associated with an authorised user.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision arrangement for providing an aerosol to an authorised user, the aerosol provision arrangement comprising:
an aerosol provision device comprising control circuitry for receiving signals and controlling an activation state of the aerosol provision device;
an emitter associated with an authorised user, arranged to send a signal to the control circuitry of the aerosol provision device; and
a power source,
wherein the emitter comprises energy reception circuitry arranged to receive, indirectly, energy from the power source, and
wherein the control circuitry is arranged to change an activation state of the aerosol provision device upon receiving a signal from the emitter associated with an authorised user.

2. An aerosol provision arrangement according to claim 1, wherein the power source is separate to the emitter and the aerosol provision device.

3. An aerosol provision arrangement according to claim 1, wherein the emitter comprises a main body, the main body comprising the energy reception circuitry and emitter circuitry for sending the signal to the control circuitry of the aerosol provision device.

4. An aerosol provision arrangement according to claim 1, wherein the energy reception circuitry comprises an antenna, for example, a patch antenna.

5. An aerosol provision arrangement according to claim 1, wherein the control circuitry is arranged to change an activation state of the aerosol provision device from a default activation state to a first activation state upon receiving a first signal from a first emitter, and wherein the control circuitry is arranged to change an activation state of the aerosol provision device from a default activation state to a second activation state upon receiving a second signal from a second emitter, wherein the first signal is associated with a first user and the second signal is associated with a second user.

6. An aerosol provision arrangement according to claim 5, wherein the first user is a first authorised user and the first activation state is a first operating state.

7. An aerosol provision arrangement according to claim 6, wherein the second user is a second authorised user and the second activation state is a second operating state, wherein the second operating state is different to the first operating state.

8. An aerosol provision arrangement according to claim 5, wherein the second user is an unauthorised user and the second activation state is a non-operating, locked state.

9. An aerosol provision arrangement according to claim 6, wherein the default activation state is a non-operating state.

10. An aerosol provision arrangement according to claim 1, wherein the emitter is arranged to transmit signals up to a range of 15 meters.

11. An aerosol provision arrangement according to claim 1, wherein the emitter is arranged to transmit signals up to a range of 2 meters.

12. An aerosol provision arrangement according to claim 1, wherein
the emitter is a Bluetooth token,
the power source is a battery of a mobile telecommunications device,
wherein the emitter is arranged to abut the mobile telecommunications device and use energy in transmissions from the mobile telecommunications device to emit Bluetooth signals.

13. A method of providing an aerosol from an aerosol provision arrangement, the method comprising:
operating a power source to emit energy;
using, by an emitter, at least a portion of the emitted energy from the power source to send a signal;
receiving, by control circuitry, the signal from the emitter;
reviewing, by the control circuitry, the signal against a signal repository;
changing, by the control circuitry, an activation state of an aerosol provision device according to the signal.

14. A method according to claim 13, wherein reviewing, by the control circuitry, the signal against a signal repository comprises:
accessing the signal repository;
checking the signal from the emitter against signals recorded as authorised in the signal repository; and,
determining whether the signal is from an authorised emitter or an unauthorised emitter.

15. A method according to claim 13, using, by an emitter, at least a portion of the emitted energy from the power source to send a signal comprises:
sending, by the emitter, a personal area network signal.

16. A method according to claim 13, wherein upon determining the signal is from an authorised emitter, changing the activation state of an aerosol provision device to an operating state.

17. An aerosol provision means comprising:
an aerosol provision device comprising control means for receiving signals and controlling an activation state of the aerosol provision device; and,
emitting means associated with an authorised user, arranged to send a signal to the control means of the aerosol provision device,
power means,
wherein the emitting means comprises energy reception circuitry arranged to receive, indirectly, energy from the power means, and
wherein the control means is arranged to change an activation state of the aerosol provision device upon receiving a signal from the emitting means associated with an authorised user.
